(19) United States
(12) Patent Application Publication
(10) Pub. No.: US 2025/0202716 A1
(43) Pub. Date: Jun. 19, 2025

(54) CLOUD LAUNCH APPLICATION SECURITY PARAMETERS (CLASP)

(71) Applicant: Wells Fargo Bank, N.A., San Francisco, CA (US)

(72) Inventor: Jeffrey J. Stapleton, O'Fallon, MO (US)

(73) Assignee: Wells Fargo Bank, N.A., San Francisco, CA (US)

(21) Appl. No.: 18/539,667

(22) Filed: Dec. 14, 2023

(51) Int. Cl. H04L 9/32; H04L 9/08; H04L 9/30

(52) U.S. Cl. CPC H04L 9/3263; H04L 9/088; H04L 9/30

(57) ABSTRACT

The arrangements disclosed herein relate to systems, apparatus, methods, and non-transitory computer readable media for splitting Application Security Parameters (ASP) of an application into a first number of splits, the first number of splits is identified by an Application Identifier (AID) of the application, storing each of the first number of splits and the AID in a respective one of a plurality of secure storages, retrieving a second number of splits from the plurality of secure storages using the AID, and determining the ASP by reassembling the second number of splits, wherein the application is configured to be launched or updated using the ASP.

### BACKGROUND

Conventionally, cloud applications are either preconfigured using generic security parameters or configured at launch using security parameters received from a central repository as unencrypted cleartext. Preconfiguring the cloud applications with generic security parameters across all instances of the application increases the risk of compromise as an attack on one instance of the application can be the same as an attack on all instances of the application. Transmitting the security parameters from a central repository greatly increases the risk of compromise as an attacker can intercept the security parameters during transmission. Cloud applications that generate keys and fetch public key certificates per instance have increased startup time and complex key management. Key Management Infrastructures (KMIs) that service such cloud applications are required to have fast response times and high available rates.

### SUMMARY

The arrangements disclosed herein relate to systems, methods, non-transitory computer-readable media, and apparatuses for splitting Application Security Parameters (ASP) of an application into a first number of splits, the first number of splits is identified by an Application Identifier (AID) of the application, storing each of the first number of splits and the AID in a respective one of a plurality of secure storages, retrieving a second number of splits from the plurality of secure storages using the AID, and determining the ASP by reassembling the second number of splits. The application is configured to be launched or updated using the ASP.

These and other features, together with the organization and manner of operation thereof, will become apparent from the following detailed description when taken in conjunction with the accompanying drawings.

### BRIEF DESCRIPTION OF THE DRAWINGS

FIG. 1 is a diagram illustrating an example method for providing Application Security Parameters (ASP) to an application using Cloud Launch ASP (CLASP) splits, according to various arrangements.

FIG. 2 is a diagram illustrating an example method for providing ASP to an application using CLASP splits, according to various arrangements.

FIG. 3 is a block diagram of a system including an example computing device, an example storage computing device, and an example application computing system, according to some arrangements.

FIG. 4 is a diagram illustrating an example method for providing ASP to an application using CLASP splits, according to various arrangements.

### DETAILED DESCRIPTION

The arrangements disclosed herein relate to systems, apparatuses, methods, and non-transitory computer-readable media for securely launching and updating cloud Application Security Parameters (ASP) to application cloud instances using at least one of components or secret sharing schemes, commonly referred to as splits. In some arrangements, splits of the ASP can be provided to an application in an N-of-N scheme in which all splits are needed to reassemble the ASP. In some arrangements, secret sharing schemes use a threshold N splits of M splits (e.g., N<M), based on which N splits are needed to reassemble the ASP. At no time is the ASP stored as a whole. That is, the entire ASP cannot be stored in one location, and can instead be stored only in isolation as splits. This protects the splits using dual controls with split knowledge. The ASP can only be reassembled by the cloud application instance in a volatile memory of a computing system.

In some arrangements, the ASP can include cryptographic material. In some examples, cryptographic material as used herein refers to any tangible information that can be used in cryptographic operations (e.g., cryptographic processes or cryptographic algorithms) to encrypt, decrypt, sign, signcrypt, validate, authenticate, or protect sensitive information. Examples of the cryptographic material include a cryptographic key (e.g., a private key, a public key, a symmetric key, an asymmetric key, a secret key, a key encryption key, and so on), information (e.g., a secret parameter, a random number, a seed, a key component, an initialization vector, and so on) used to generate or derive a cryptographic key, authentication code, and so on. The ASP can be expressed using an alphanumeric string (which can be encoded as a binary string), a binary string, and so on. In some examples, the ASP include binary data such as symmetric keys, asymmetric private keys, passwords, and other suitable critical security parameters.

In some examples, the ASP can include a password configured to unlock an object. In some examples, the object can be a cryptography object or container containing authentication credentials, signing credentials, and so on. For example, the object can include at least one of encrypted passwords, encrypted symmetric keys, encrypted asymmetric private keys, encrypted public key certificates, Certificate Pinning Lists (CPLs), and so on. Examples of the object can include an object defined under Public-Key Cryptography Standards (PKCS), such as a PKCS #12 object. Examples of the object can include a PKCS #12 container, which is used to send cryptographic keys from a Hardware Security Module (HSM) to an application.

In some examples, the ASP can include a parameter or value used to initiate a Database Encryption Key Management (DBEKM) scheme as described in ANSI X9.73 Cryptographic Message Syntax, U.S. Pat. No. 10,615,969, titled “DATABASE ENCRYPTION KEY MANAGEMENT,” filed on Nov. 14, 2017, U.S. Pat. No. 11,095,438, titled “DATABASE ENCRYPTION KEY MANAGEMENT,” filed on Apr. 6, 2020, U.S. Patent No. 11,683, 158, titled “DATABASE ENCRYPTION KEY MANAGEMENT,” filed on Aug. 9, 2021, and U.S. Patent Publication No. 2023/0283,456, titled “DATABASE ENCRYPTION KEY MANAGEMENT,” filed on May 9, 2023, the entire contents of which are incorporated herein by reference in their entireties. In some examples, the ASP can include an encrypted HMAC key (e.g., MK(HK)) decrypted by the HSM using the master key (MK) to compute a seed (HMAC (HK, ID)), an application ID used for DBEKM, a seed or a shared secret based on which the Database Encryption Key (DEK) is generated. For example, the DEK can be generated using the seed (e.g., the ASP) as an input to a key derivation algorithm or function.

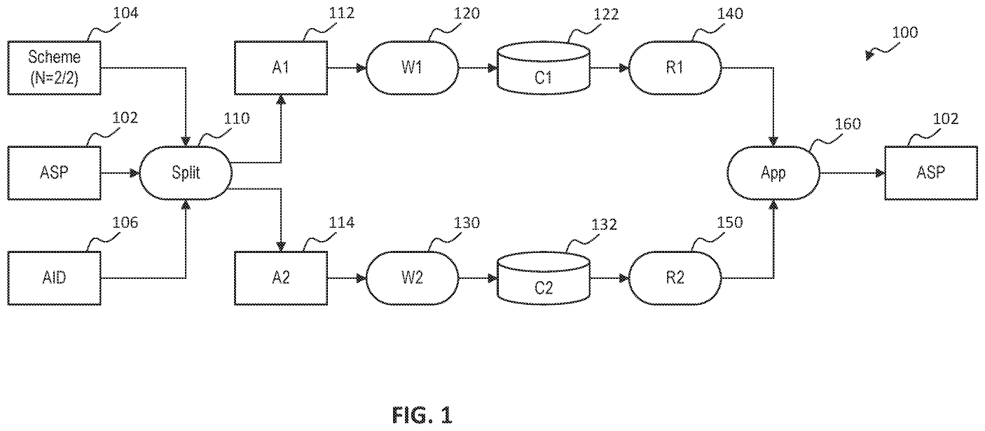

FIG. 1 is a diagram illustrating an example method 100 for providing ASP to an application 160 using Cloud Launch ASP (CLASP) splits, according to various arrangements. The method 100 includes a write method and an application method. The write method includes a split function 110, a write function 120, and a write function 130. The application method includes a read function 140, a read function 150, and an application 160. The CLASP splits include the splits 112 and 114.

In some examples, ASP 102, a scheme 104, and an Application Identifier (AID) 106 are provided as inputs into a split function 110. The scheme 104 can indicate configurations, e.g., N-of-N, for the split function 110. In the example shown in FIG. 1, the scheme 104 includes splitting the ASP 102 into a number (e.g., two) of splits (e.g., components, partitions, divisions, portions, and so on), all of which are needed to reassemble the ASP 102, e.g., N/N=2/2. The AID 106 identifies an application (e.g., the application 160) for which the ASP 102 is to be applied. The split function 110 splits the ASP 102 into a number of splits indicated by the scheme 104. As shown, the ASP 102 are split into two splits, a first split 112 (A1) and a second split 114 (A2). In some examples, the split function 110 can generate the number of splits indicated by the scheme 104 such that the generated splits can be combined using Exclusive Or (XOR) to recover the ASP 102. For example, in the examples in which the splits are binary strings of 0s and 1s, a first split of the N splits and a second split of the N splits are bitwise XORed to obtain a first result, the first result and a third split are bitwise XORed to obtain a second result, . . . , the (N-1)th result and an Nth split are bitwise XORed to obtain the ASP 102. Each split has a same length as that of the ASP 102.

Each of the splits 112 and 114 is provided to other processes such as the write processes 120 (W1) and 130 (W2) along with the AID 106. For example, the first split 112 and the AID 106 are provided to the write process 120, which writes the first split 112 and the corresponding AID 106 to a first secure storage 122 (C1). The first split 112 and the AID 106 can be encrypted before being written into the first secure storage 122. The second split 114 and the AID 106 are provided to the write process 130, which writes the second split 114 and the corresponding AID 106 to a second secure storage 132 (C2). The second split 114 and the AID 106 can be encrypted before being written into the second secure storage 132.

Subsequently, the application 160 can access and retrieve the N splits of its ASP 102 using the AID 106 identifying the application 160. For example, the application 160 can provide its AID 106 to each of the N separate processes such as the read processes 140 (R1) and the read processes 150 (R2) to read the respective splits stored in the secure storages 122 and 132. The secure storages 122 and 132 each authenticates and authorizes the AID 106, decrypts the respective one of the splits 112 and 114 (if encrypted before storage) stored in the respective secure storages 122 and 132, and provides that split to the application 160.

The read process 140 can provide the AID 106 to the first secure storage 122. The first secure storage 122 or the read process 140 can authenticate and authorize the AID 106. For example, the first secure storage 122 or the read process 140 can determine whether retrieving a split for the AID 106 is presently allowed using a lookup table that includes a list of AIDs for which split reading is currently allowed. In response to authenticating and authorizing the AID 106, the first secure storage 122 retrieves the first split 112 that is associated with or mapped to the AID 106. In the examples in which the split 112 is encrypted before being stored in the first secure storage 122, the encrypted first split 112 is decrypted and provided to the application 160. The read process 150 can provide the AID 106 to the second secure storage 132. The second secure storage 132 or the read process 150 can authenticate and authorize the AID 106. For example, the second secure storage 132 or the read process 150 can determine whether retrieving a split for the AID 106 is presently allowed using a lookup table that includes a list of AIDs for which split reading is currently allowed. In response to authenticating and authorizing the AID 106, the second secure storage 132 retrieves the second split 114 that is associated with or mapped to the AID 106. In the examples in which the second split 114 is encrypted before being stored in the second secure storage 132, the encrypted second split 114 is decrypted and provided to the application 160.

The application 160 (e.g., a cloud application instance) reassembles (e.g., combines, reconstructs, and so on) the ASP 102 using the N splits (e.g., the splits 112 and 114). In some examples, reassembling the ASP 102 includes performing a bitwise XOR on the N splits. For example, in the examples in which the splits are binary strings of 0s and 1s, the application 160 performs bitwise XOR for a first split of the N splits and a second split of the N splits to obtain a first result, performs bitwise XOR for the first result and a third split to obtain a second result, . . . , and performs bitwise XOR for the (N-1)th result and an Nth split to obtain the ASP 102. The ASP 102 can only be reassembled by the application 160 in a volatile memory (e.g., the volatile memory 362) of a computing system executing the application 160. Each split has a same length as that of the ASP 102.

In some arrangements, the application 160 retrieves all N splits of the ASP 102 from the read processes (e.g., the read processes 140 and 150) to reassemble the ASP 102 according to the scheme 104. Otherwise, if a number of splits retrieves is less than N, the ASP 102 cannot be reassembled due to the information needed to reassemble the ASP 102 is insufficient. The reassemble therefore fails.

In the example shown in FIG. 1 where N=2, both splits are needed to reassemble the ASP 102. In the examples in which N=3, all three splits are needed to reassemble the ASP 102 for the same N/N scheme. In the examples in which N=4, all four splits are needed, to reassemble the ASP 102 for the same N/N scheme, etc. Accordingly, the ASP 102 cannot be determined by an attacker unless all the N splits are compromised (e.g., all of the N secure storages are compromised or all N splits are intercepted during transmission, and that all N splits are guessed correctly). The guessing of any split has a same low probability of guessing the ASP 102, in the examples in which the ASP 102 itself is random. For instance, each data-bit has a 0.5probability, so that a 256-bit ASP has 2-256 or 8.6×10-78 chance of being guessed correctly.

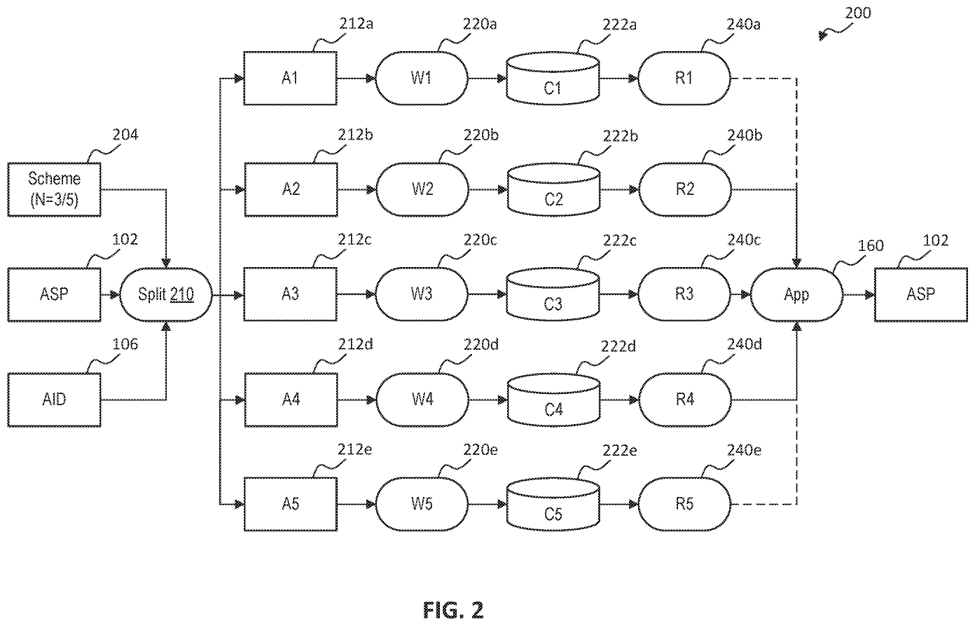

FIG. 2 is a diagram illustrating an example method 200 for providing the ASP 102 to the application 160 using CLASP splits, according to various arrangements. The method 200 includes a write method and an application method. The write method includes a split function 210 and write functions 220a, 220b, 220c, 220d, and 220e. The application method includes read functions 240a, 240b, 240c, 240d, and 240e and an application 160. Examples of the CLASP splits include splits 212a, 212b, 212c, 212d, and 212e.

In some examples, the ASP 102, a scheme 204, and the AID 106 are provided as inputs into a split function 210. The scheme 204 can indicate configurations, e.g., N-of-M, for the split function 210. In the example shown in FIG. 2, the scheme 204 includes splitting the ASP 102 into a number (e.g., five) of splits, three of which are needed to reassemble the ASP 102, e.g., N/M=3/5. The AID 106 identifies the application 160 for which the ASP 102 is to be applied. The split function 210 splits the ASP 102 into a number (e.g., M=5) of splits indicated by the scheme 204. As shown, the ASP 102 are split into five splits, a first split 212a (A1), a second split 212b (A2), a third split 212c (A3), a fourth split 212d (A4), and a fifth split 212e (A5). In some examples, the split function 210 can generate M splits indicated by the scheme 204 such that N of the M generated splits can be combined using XOR to recover the ASP 102.

In some examples, the scheme 204 includes Shamir's secret sharing scheme, in which an original secret (e.g., the ASP 102) is used to create M splits (e.g., shares, partitions, divisions, portions, and so on) and only a threshold number N (N <M) splits are needed to recover the original secret. In some examples, the M splits (e.g., the splits 212a, 212b, 212c, 212d, and 212e) are created using at least one mathematical equation of Shamir's secret sharing scheme. Thus, unlike schemes which need all splits to recover the secret (such as the mechanism illustrated in FIG. 1), the Shamir's secret sharing scheme needs N out of M splits to recover the ASP 102.

Each of the splits 212a, 212b, 212c, 212d, and 212e is provided to other processes such as respective ones of the write processes 220a (W1), 220b (W2), 220c (W3), 220d (W4), and 220e (W5) along with the AID 106. For example, the first split 212a and the AID 106 are provided to the write process 220a, which writes the first split 212a and the corresponding AID 106 to a first secure storage 222a (C1). The first split 212a and the AID 106 can be encrypted before being written into the first secure storage 222a. The second split 212b and the AID 106 are provided to the write process 220b, which writes the second split 212b and the corresponding AID 106 to a second secure storage 222b (C2). The second split 212b and the AID 106 can be encrypted before being written into the second secure storage 222b. The third split 212c and the AID 106 are provided to the write process 220c, which writes the third split 212c and the corresponding AID 106 to a third secure storage 222c (C3). The third split 212c and the AID 106 can be encrypted before being written into the third secure storage 222c. The fourth split 212d and the AID 106 are provided to the write process 220d, which writes the fourth split 212d and the corresponding AID 106 to a fourth secure storage 222d (C4). The fourth split 212d and the AID 106 can be encrypted before being written into the fourth secure storage 222d. The fifth split 212e and the AID 106 are provided to the write process 220e, which writes the fifth split 212e and the corresponding AID 106 to a fifth secure storage 222e (C5). The fifth split 212e and the AID 106 can be encrypted before being written into the fifth secure storage 222e.

Subsequently, in some arrangements, the application 160 can access and retrieve the N splits of its ASP 102 using the AID 106 identifying the application 160. For example, the application 160 can provide its AID 106 to N (e.g., 3) separate processes such as the read process 240b (R2), read process 240c (R3), and the read process 240d (R4) to read the respective splits stored in the secure storages 222b, 222c, and 222d. The secure storages 222b, 222c, and 222d each authenticates and authorizes the AID 106, decrypts a respective one of the splits 212b, 212c, and 212d (if encrypted before storage) stored in the respective secure storages 222b, 222c, and 222d, and provides that split to the application 160.

In some arrangements, the application 160 can attempt to access and retrieve all M splits of its ASP 102 using the AID 106 identifying the application 160. For example, the application 160 can provide its AID 106 to M (e.g., 5, or a number between M and N) separate processes such as the read process 240a (R1), read process 240b (R2), read process 240c (R3), the read process 240d (R4), and the read process 240e (R5) to read the respective splits stored in the secure storages 222a, 222b, 222c, 222d, and 222e. In response to receiving the AID 106, the secure storages 222a, 222b, 222c, 222d, and 222e each authenticates and authorizes the AID 106, decrypts a respective one of the splits 212a, 212b, 212c, 212d, and 212e (if encrypted before storage) stored in the respective secure storages 222a, 222b, 222c, 222d, and 222e, and provides that split to the application 160. Given that only N splits are needed to reassemble the ASP 102, the application 160 can assemble the first N splits (e.g., the splits 240b, 240c, and 240d) that the application 160 receives to determine the ASP 102. The first N splits refer to the N splits received by the application 160 first in time. The application 160 can discard any split received after the first N splits are received.

Various reasons can cause the application 160 to not receive a split (in time), such as a read process failing to receive the AID 106 or the request, the application 160 failing to receive the split from the read process, the received split is corrupt or erroneous, network delay, processing delays, the secure storage being offline, the secure storage or the read process experiencing load busier than a threshold load, geographical distance between the secure storage and the computing system running the application 160, and so on.

Each of the read processes 240a, 240b, 240c, 240d, and 240e, upon successfully receiving the AID 106, can provide the AID 106 to a respective secure storage (e.g., one of secure storages 222a, 222b, 222c, 222d, and 222e). The secure storage or the corresponding read process can authenticate and authorize the AID 106. For example, the secure storage or the read process can determine whether retrieving a split for the AID 106 is presently allowed using a lookup table that includes a list of AIDs for which split reading is currently allowed. In response to authenticating and authorizing the AID 106, the secure storage retrieves the split that is associated with or mapped to the AID 106. In the examples in which the split is encrypted before being stored in the secure storage, the encrypted split is decrypted and provided to the application 160.

The application 160 (e.g., a cloud application instance) reassembles (e.g., combines, reconstructs, and so on) the ASP 102 using the N splits (e.g., the splits 212b, 212c, and 212d). In some examples, reassembling the ASP 102 includes performing a bitwise XOR on the N splits. For example, in the examples in which the splits are binary strings of 0s and 1s, the application 160 performs bitwise XOR for a first split of the N splits and a second split of the N splits to obtain a first result, performs bitwise XOR for the first result and a third split to obtain a second result, . . . , performs bitwise XOR for the (N-1)th result and an Nth split to obtain the ASP 102. The ASP 102 can only be reassembled by the application 160 in a volatile memory of a computing system executing the application 160.

In some arrangements, the application 160 retrieves all N (N<M) splits of the ASP 102 from N read processes (e.g., N of the read processes 240a, 240b, 240c, 240d, and 240e) to reassemble the ASP 102. Otherwise, if a number of splits retrieves is less than N, the ASP 102 cannot be reassembled due to the information needed to reassemble the ASP 102 is insufficient, and the reassemble therefore fails.

In the example shown in FIG. 2 where N=3, all N splits are needed to reassemble the ASP 102. Accordingly, the ASP 102 cannot be determined by an attacker unless all the N splits are compromised (e.g., all of the N out of the M secure storages are compromised or all N out of the M splits are intercepted during transmission, and that all N out of M splits are guessed correctly). The number of splits needed to reassemble the ASP 102, e.g., N, represents a minimum threshold of splits for reassembling the ASP. The guessing of any split has a same low probability of guessing the ASP, as described.

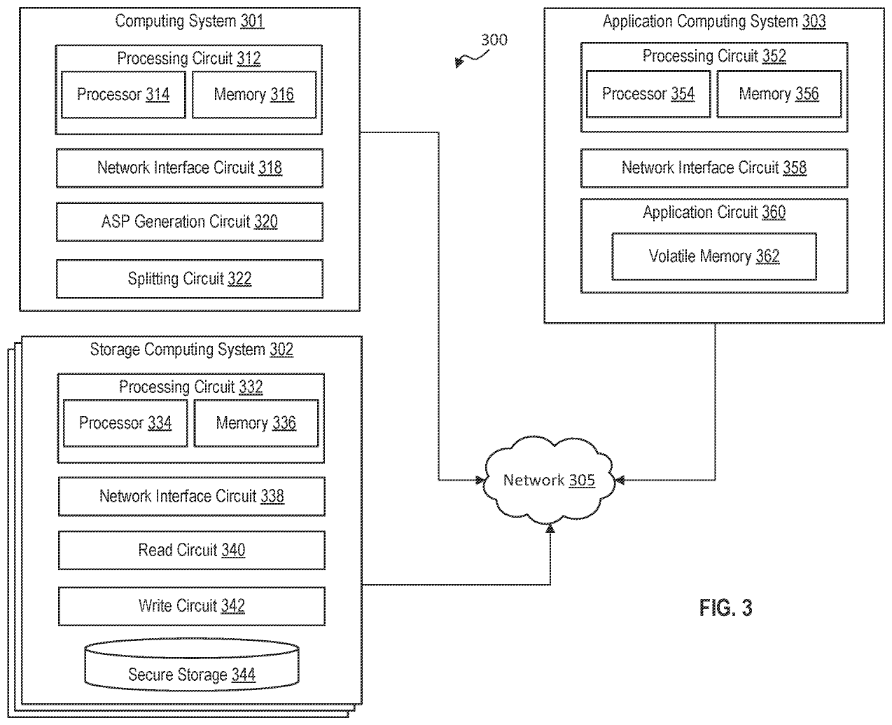

FIG. 3 is a block diagram of a system 300 including an example computing system 301, example storage computing devices 302, and an example application computing system 303, according to some arrangements. In some examples, the computing system 301 can generate the ASP 102 and splits the ASP 102 (e.g., at 110 or 210). The storage computing devices 302 can include respective secure storages 342 (e.g., secure storages 122, 132, 222a, 222b, 222c, 222d, 222e) and perform the write functions (e.g., write functions 120, 130, 220a, 220b, 220c, 220d, and 220e) and read functions (e.g., read functions 140, 150, 240a, 240b, 240c, 240d, and 240e) with respect to the secure storages 324. The application computing system 303 can execute the applications 160. As shown, the systems 301, 302, and 303 are physically separate hardware systems located on different nodes of the network 305. In other examples, two or more of the systems 301, 302, and 303 can physically run on the same hardware system (e.g., within the same network node) and are separated using one or more firewalls, such that each of the two or more of the systems 301, 302, and 303 operate within respective security zones.

The devices 301, 302, and 303 can communicate with one another via a network 305. The network 305 can include any suitable Local Area Network (LAN), Wide Area Network (WAN), or a combination thereof. For example, the network 305 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1x Radio Transmission Technology (1x), General Packet Radio Service (GPRS), Personal Communications Service (PCS), 802.11X, ZigBee, Bluetooth, Wi-Fi, any suitable wired network, combination thereof, and/or the like. The network 305 is structured to permit the exchange of data, values, parameters, signals, instructions, messages, and the like. In some arrangements, the communications be among the devices 301, 302, and 303 can be performed over one or more secure connections, such as Transport Layer Security (TLS) or Secure Shell (SSH).

The computing system 301 can include a suitable computing system such as a desktop computer, laptop computer, smart phone, tablet, server, on-premise computing system, datacenter, cloud computing system, and so on. The computing system 301 is shown to include various circuits and logic for implementing the operations described herein. More particularly, the computing system 301 includes one or more of a processing circuit 312, a network interface circuit 318, an ASP generation circuit 320, and a splitting circuit 322. While various circuits, interfaces, and logic with particular functionality are shown, it should be understood that the computing system 301 includes any number of circuits, interfaces, and logic for facilitating the operations described herein. For example, the activities of multiple circuits are combined as a single circuit and implemented on a same processing circuit (e.g., the processing circuit 312), as additional circuits with additional functionality are included.

In some arrangements, the processing circuit 312 includes a processor 314 and a memory 316. The processor 314 is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 316 (e.g., Random Access Memory (RAM), Read-Only Memory (ROM), Non-Volatile RAM (NVRAM), flash memory, hard disk storage, etc.) stores data and/or computer code for facilitating the various processes described herein. Moreover, the memory 316 is or includes tangible, non-transient volatile memory or non-volatile memory. Accordingly, the memory 316 includes database components, object code components, script components, or any other type of information structure for supporting the various activities and information structures described herein. The processing circuit 312 can be used to implemented one or more of the circuits 318, 320, and 322.

The network interface circuit 318 is configured for and structured to establish a connection and communicate with the devices 302 and 303 via the network 305 or another suitable wired, wireless, or physical connection. The network interface circuit 318 is structured for sending and receiving data over a communication network (e.g., the network 305) or a physical connection (e.g., via a physical connector such as Universal Serial Bus (USB)). Accordingly, the network interface circuit 318 includes any of a cellular transceiver (for cellular standards), wireless network transceiver (for 802.11X, ZigBee, Bluetooth, Wi-Fi, or the like), wired network interface, or a combination thereof. For example, the network interface circuit 318 may include wireless or wired network modems, ports, baseband processors, and associated software and firmware.

The ASP generation circuit 320 is configured to generate the ASP 102 for an application (e.g., the application 160) in some arrangements. The ASP generation circuit 320 can generate any types of the ASP 102 as described herein. In the examples in which the ASP 102 is random, the ASP generation circuit 320 includes or implements a random number generator or a quantum number generator that generates a random binary string or alphanumeric string to be used as the ASP 102.

The splitting circuit 322 is configured to split the generated ASP 102 into multiple splits 112, 114, 212a, 212b, 212c, 212d, and 212e. For example, the splitting circuit 322 can execute the split functions 110 and 210 to split the ASP 102 according to the schemes 104 and 204.

Each storage computing system 302 can include a suitable computing system such as a desktop computer, laptop computer, smart phone, tablet, server, on-premise computing system, datacenter, cloud computing system, and so on. The storage computing system 302 is shown to include various circuits and logic for implementing the operations described herein. More particularly, the storage computing system 302 includes one or more of a processing circuit 332, a network interface circuit 338, a read circuit 340, a write circuit 342, and a secure storage 344. While various circuits, interfaces, and logic with particular functionality are shown, it should be understood that the storage computing system 302 includes any number of circuits, interfaces, and logic for facilitating the operations described herein. For example, the activities of multiple circuits are combined as a single circuit and implemented on a same processing circuit (e.g., the processing circuit 332), as additional circuits with additional functionality are included.

In some arrangements, the processing circuit 332 has a processor 334 and memory 336. The processor 334 is a processing component such as the processor 314. The memory 336 is a memory device such as the memory 316. The processing circuit 332 can be used to implemented one or more of the circuits 338, 340, 342, and 344.

The network interface circuit 338 is a network device such as the network interface circuit 318. The network interface circuit 338 is configured for and structured to establish a connection and communicate with the computing system 301 and the application computing system 303 via the network 305 or another suitable wired, wireless, or physical connection.

The secure storage 344 can include any suitable memory device, database, datacenter, KMS, and so on that can securely store sensitive information such as the splits 112, 114, 212a, 212b, 212c, 212d, and 212e of the ASP 102. The secure storage 344 never stores the ASP 102 as a whole, only its splits. Examples of the secure storage 344 include the secure storages 120, 130, 222a, 222b, 222c, 222d, and 222e. In some examples, the processing circuit 332 can encrypt the splits of the ASP 102 before writing the splits of the ASP 102 into the secure storage 344 and decrypt the encrypted splits of the ASP 102 after reading the encrypted splits.

The read circuit 340 is configured to perform a read function (e.g., the read functions 140, 150, 240a, 240b, 240c, 240d, and 240e) to read (e.g., retrieve, obtain) data such as splits 112, 114, 212a, 212b, 212c, 212d, and 212e of the ASP 102 stored in the secure storage 344. For example, in response to receiving a read command from the application computing system 303 including the AID 106, the read circuit 340 determines a logical and/or physical address corresponding to the AID 106 and read the split from the logical and/or physical address. The network interface circuit 338 can receive the read command with the AID 106 from the application computing system 303 via the network 305 and send the split that has been read to the application computing system 303 via the network 305. In some examples, the secure storage 344 or the read circuit 340 can determine whether retrieving a split for the AID 106 is presently allowed using a lookup table that includes a list of AIDs for which split reading is currently allowed. The lookup table can be provided and updated by the computing system 301 or another suitable computing system via the network 305.

The write circuit 342 is configured to perform a write function (e.g., the write functions 120, 130, 220a, 220b, 220c, 220d, and 220e) to write (e.g., store, program) data such as splits 112, 114, 212a, 212b, 212c, 212d, and 212e of the ASP 102 in the secure storage 344. For example, in response to receiving a write command from the computing system 301 including a split and the AID 106, the write circuit 342 determines a logical and/or physical address corresponding to the AID 106 and writes the split to the logical and/or physical address. The network interface circuit 338 can receive the write command including the split and the AID 106 from computing system 301 via the network 305.

Although FIG. 3 shows that a single storage computing system 302 includes the read circuit 340, the write circuit 342, and the secure storage 344, two or more of the read circuit 340, the write circuit 342, and the secure storage 344 can reside on different computing systems that are communicable coupled to each other via the network 305. Each storage computing system 302 can store within the secure storage 344 splits of different applications (e.g., thousands or tens of thousands of applications).

As shown, the system 300 includes multiple storage computing systems 302, each of which corresponds to a combination of a write function, a secure storage, and a read function. As described, a split function 110 or 210 can split a given ASP 102 into a first number of splits of the ASP 102, each split to be stored in a respective one of a first number of storage computing systems 302. The first number of storage computing systems 302 (e.g., the first number of secure storages 344) are different systems, are located on different network nodes, are different types of databases or datacenters, are operated by different service providers, are located on different cloud services, are physically located in different geographical locations, and so on. In some examples, the storage computing systems 302 can be physically distributed across a geographical region to increase the likelihood that the application 160 can receive sufficient number of responses (e.g., N for schemes 104 and 204) within reasonable time, regardless of where the application computing system 303 or the application circuit 360 is physically located within the region.

The application computing system 303 can include a suitable computing system such as a desktop computer, laptop computer, smart phone, tablet, server, on-premise computing system, datacenter, cloud computing system, and so on. The application computing system 303 is shown to include various circuits and logic for implementing the operations described herein. More particularly, the application computing system 303 includes one or more of a processing circuit 352, a network interface circuit 358, and an application circuit 360. While various circuits, interfaces, and logic with particular functionality are shown, it should be understood that the application computing system 303 includes any number of circuits, interfaces, and logic for facilitating the operations described herein. For example, the activities of multiple circuits are combined as a single circuit and implemented on a same processing circuit (e.g., the processing circuit 352), as additional circuits with additional functionality are included.

In some arrangements, the processing circuit 352 has a processor 354 and memory 356. The processor 354 is a processing component such as the processor 312. The memory 356 is a memory device such as the memory 316. The processing circuit 352 can be used to implemented one or more of the circuits 358 and 360.

The network interface circuit 358 is a network device such as the network interface circuit 318. The network interface circuit 358 is configured for and structured to establish a connection and communicate with the computing system 301 and the storage computing system 302 via the network 305 or another suitable wired, wireless, or physical connection.

In some examples, the application circuit 360 is configured to execute the application 160 such as a cloud application, a cloud-based application, an application running on virtual environment, and so on. The cloud application can reside in a volatile memory 362 such that the cloud application can be initiated (e.g., spun up) and terminated (e.g., wind down) with no local disk storage. That is, the data of the application 160 is stored only in the volatile memory 362 and is not stored in the memory 356 or in a non-volatile memory of the application computing system) of the application or configuration parameters (e.g., the ASP 102). In some examples, golden images are stored on dedicate storage (e.g., the volatile memory 362) for allocation to any cloud server with sufficient resources to run the application 160. Unlike legacy server with local disk storage for operating systems, executable application images, and application configuration data, cloud servers do not store executable application images or application configuration data in a non-volatile memory. Unique configuration data, including the ASP 102, is provided to each application instance.

For example, the same application running in three different instances (e.g., using a corresponding number of different application computing systems) may not use the same TLS public key certificate and associated private key. Each instance needs its own keys for identity, authentication, authorization, and compartmentalization. In the examples in which greater than ten instances are allowed, ten sets of application keys would need to be allocated. Provisioning the complete set of keys to every instance, where each instance can use only the appropriate keys, has the inherent risks of misuse and key compromise. An attack on one instance would be the same as an attack on all instances.

Implementations that include provisioning the keys dynamically, where each instance generates its own keys or fetches keys from a centralized key manager, require time to generate asymmetric key pairs and issue public key certificates, making such implementations burdensome and problematic. An alternative can be a central configuration store for ASP where each instance of the application can fetch the unique information. However, transmitting the entire ASP to an application instance when no critical security parameters (e.g., cryptographic keys) have yet been established as the application is initiated risks compromise.

Accordingly, the arrangements of the present disclosure can facilitate launching of a cloud application and providing unique and specific ASP 102 to that application using splits. Once the splits of the ASP 102 are reassembled to obtain the ASP 102, other critical security parameters can be securely transmitted to the application from a cloud KMS in some examples, where ASP 102 can be used to encrypt, decrypt, sign, verify, authenticate, or signcrypt such additional security parameters.

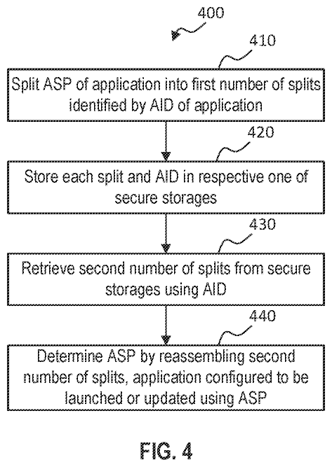

FIG. 4 is a diagram illustrating an example method 400 for providing the ASP 102 to an application 160 using CLASP splits, according to various arrangements. The method 400 can be performed by the computing system 301, the storage computing system 302, and the application computing system 303. The method 400 can be implemented to provide the ASP 102 used in launching the application 160 or to update the ASP 102 after the application 160 has been launched. The methods 100 and 200 are particular implementations of the method 400.

At 410, the computing system 301 (e.g., the splitting circuit 322) splits the ASP 102 of the application 160 into a first number of splits. Each of the first number of splits is identified by an AID 106 of the application 160.

At 420, each of the first number of splits and the AID 106 is stored in a respective one of a plurality of secure storages 344. For example, each of a plurality of storage computing systems 302 (e.g., the write circuit 342 thereof) stores or writes, using a write function, a respective one of the first number of splits and the AID 106 in a secure storage 344 of that storage computing system 302. In some examples, each of the first number of splits is encrypted. Each of the first number of encrypted splits is stored in the respective one of the plurality of secure storages 344.

At 430, to launch the application or update the ASP 102, the application computing system 303 (e.g., the application circuit 360) retrieving a second number of splits from the plurality of secure storages 344 using the AID 106. At 440, the application computing system 303 (e.g., the application circuit 360) determines the ASP 102 by reassembling the second number of splits. The application 160 is configured to be launched or updated by the application circuit 360 using the ASP 102. The ASP 102 can be stored in the volatile memory 362.

In some examples, the ASP 102 includes binary data. The binary data includes at least one of a symmetric key, an asymmetric private key, a password, or a critical security parameter. The binary data can be used to derive at least one of a symmetric key, an asymmetric private key, a password, or a critical security parameter. In some examples, the ASP 102 can be inputted into a key derivation function or a key derivation algorithm to generate or derive drive at least one of a symmetric key, an asymmetric private key, a password, or a critical security parameter. In some examples, the ASP 102 includes a password configured to unlock an object containing at least one of encrypted passwords, encrypted symmetric keys, encrypted asymmetric private keys, encrypted public key certificates, or Certificate Pinning Lists (CPLs). In some examples, the ASP 102 is used in a DBEKM scheme.

In some examples, the application circuit 360 stores the second number of splits in the volatile memory 362 of the application computing system 303 to be reassembled. In some examples, the application circuit 360 stores the determined ASP 102 in the volatile memory 362. In response to determining that the ASP 102 has already been used by the application 160 (e.g., ASP 102 has already been used to encrypt, decrypt, sign, verify, signcrypt, or authenticate data), the application circuit 360 destroys (e.g., removes, deletes, flushes, erases, and so on) the ASP 102 in the volatile memory 362.

In some examples, the first number of splits and the second number of splits are the same, as described with respect to FIG. 1. In some examples, the first number of splits and the second number of splits are different, and the second number is less than the first number, as described with respect to FIG. 2. In some examples, the ASP 102 is split into the first number of splits using Shamir's secret sharing scheme, as described with respect to FIG. 2. In some examples, each of the first number of splits has a same length as that of the ASP 102. Each of the second number of splits has a same length as that of the ASP 102.

In some examples, the ASP 102 is used by the application 106 to derive a cryptographic key. In some examples, the ASP 102 is used by the application 106 as a cryptographic key to encrypt data, decrypt data, sign data, verify data, authenticate data, signcrypt data, or establish a secure connection (e.g., to establish keys for an TLS). Examples of the data include messages, sensitive information, and other cryptographic material. In some examples, the ASP 102 can be a key (e.g., a Key Encryption Key (KEK)) used to encrypt another cryptographic key. In some examples, the ASP 102 can be used to derive (e.g., using a suitable key derivation function or algorithm) a key (e.g., a KEK) used to encrypt another cryptographic key.

As utilized herein, the terms “approximately,” “substantially,” and similar terms are intended to have a broad meaning in harmony with the common and accepted usage by those of ordinary skill in the art to which the subject matter of this disclosure pertains. It should be understood by those of ordinary skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

Although only a few arrangements have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative arrangements. Other substitutions, modifications, changes, and omissions may also be made in the design, operating conditions and arrangement of the various exemplary arrangements without departing from the scope of the present disclosure.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), a distributed ledger (e.g., a blockchain), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web arrangements of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

What is claimed is:

1. A method, comprising:
splitting Application Security Parameters (ASP) of an application into a first number of splits, wherein the first number of splits is identified by an Application Identifier (AID) of the application;
storing each of the first number of splits and the AID in a respective one of a plurality of secure storages;
retrieving a second number of splits from the plurality of secure storages using the AID; and
determining the ASP by reassembling the second number of splits, wherein the application is configured to be launched or updated using the ASP.

2. The method of claim 1, wherein each of the first number of splits is encrypted, and each of the first number of encrypted splits is stored in the respective one of the plurality of secure storages.

3. The method of claim 1, wherein the ASP comprises binary data, wherein the binary data comprises at least one of a symmetric key, an asymmetric private key, a password, or a critical security parameter.

4. The method of claim 1, wherein the ASP comprises a password configured to unlock an object containing at least one of encrypted passwords, encrypted symmetric keys, encrypted asymmetric private keys, encrypted public key certificates, or Certificate Pinning Lists (CPLs).

5. The method of claim 1, wherein the ASP is used in a Database Encryption Key Management (DBEKM) scheme.

6. The method of claim 1, wherein
the second number of splits are stored in a volatile memory of an application computing system;
the determined ASP is stored in the volatile memory; and
in response to determining that the ASP has already been used by the application, destroying the ASP in the volatile memory.

7. The method of claim 1, wherein the first number and the second number are the same, the first number of splits are a first number of components, and the second number of splits are a second number of components.

8. The method of claim 1, wherein the first number and the second number are different, and the second number is less than the first number, wherein the first number of splits are a first number of shares, and the second number of splits are a second number of shares.

9. The method of claim 8, wherein the ASP is split into the first number of splits using Shamir's secret sharing scheme.

10. The method of claim 1, wherein
each of the first number of splits has a same length as that of the ASP; and
each of the second number of splits has a same length as that of the ASP.

11. The method of claim 1, wherein at least one of:
the ASP is used by the application to derive a cryptographic key; or
the ASP is used by the application as a cryptographic key to encrypt data, decrypt data, sign data, signcrypt data, or establish a secure connection.

12. The method of claim 1, wherein the ASP is random.

13. A system, comprising:
at least one memory; and
at least one processor configured to:
split application security parameters (ASP) of an application into a first number of splits, the first number of splits is identified by an Application Identifier (AID) of the application;
store each of the first number of splits and the AID in a respective one of a plurality of secure storages;
retrieve a second number of splits from the plurality of secure storages using the AID; and
determine the ASP by reassembling the second number of splits, wherein the application is configured to be launched or updated using the ASP.

14. The system of claim 13, wherein each of the first number of splits is encrypted, and each of the first number of encrypted splits is stored in the respective one of the plurality of secure storages.

15. The system of claim 13, wherein the ASP comprises binary data, wherein the binary data comprises at least one of a symmetric key, an asymmetric private key, a password, or a critical security parameter.

16. The system of claim 13, wherein the ASP comprises a password configured to unlock an object containing at least one of encrypted passwords, encrypted symmetric keys, encrypted asymmetric private keys, encrypted public key certificates, or Certificate Pinning Lists (CPLs).

17. The system of claim 13, wherein the ASP is used in a Database Encryption Key Management (DBEKM) scheme.

18. The system of claim 13, wherein the first number of splits and the second number of splits are the same, the first number of splits are a first number of components, and the second number of splits are a second number of components.

19. The system of claim 13, wherein the first number of splits and the second number of splits are different, and the second number is less than the first number, wherein the first number of splits are a first number of shares, and the second number of splits are a second number of shares.

20. At least one non-transitory processor-readable medium comprising processor-readable instructions, such that, when executed, causes at least one processor to:
split application security parameters (ASP) of an application into a first number of splits, the first number of splits is identified by an Application Identifier (AID) of the application;
store each of the first number of splits and the AID in a respective one of a plurality of secure storages;
retrieve a second number of splits from the plurality of secure storages using the AID; and
determine the ASP by reassembling the second number of splits, wherein the application is configured to be launched or updated using the ASP.
